(19) United States
(12) Patent Application Publication
(10) Pub. No.: US 2002/0035020 A1
(43) Pub. Date: Mar. 21, 2002

(54) Conductive roll and manufacturing method thereof

(75) Inventors: Koji Yamaguchi, Gifu-ken (JP); Yukio Oyama, Aichi-ken (JP); Naoaki Sasakibara, Aichi-ken (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Tokai Rubber Industries, Ltd., Komaki-shi (JP)

(21) Appl. No.: 09/915,356

(22) Filed: Jul. 27, 2001

(30) Foreign Application Priority Data
Jul. 28, 2000 (JP) 2000-228589

(51) Int. Cl. B25F 5/02; F16C 13/00; B21K 1/02; B23P 17/00

(52) U.S. Cl. 492/56; 492/59; 492/53; 29/895.21

(57) ABSTRACT

A conductive roll for an electrophotographic apparatus, which eliminates deposition unevenness onto the roll surface, inhibits occurrence of non-uniform roll resistance value, and gives a satisfactory image free from density unevenness. The surface of the conductive roll is corona-treated by arranging the conductive roll oppositely to, and in parallel with a discharging electrode, and impressing a voltage onto the electrode while rotating the conductive roll. With the conductive roll subjected to a corona treatment of the roll surface, deposition unevenness onto the roll surface is eliminated, a uniform roll resistance value is maintained throughout the entire surface even after use for a long period of time, thus permitting maintenance of stable properties.

### BACKGROUND OF THE INVENTION

1. Field of the Invention

The present invention relates to a conductive roll used in an electrophotographic apparatus such as a copying machine or a printer using electrophotography, particularly a charging roll, a developing roll or a transfer roll used around a photosensitive drum of such an apparatus.

2. Description of the Art

In an electrophotographic apparatus such as a copying machine or a printer using electrophotography, it is the general practice to arrange conductive rolls such as a charging roll, a developing roll and a transfer roll around a photosensitive drum for forming an electrostatic latent image.

These conductive rolls have a basic structure in which an elastic conductive layer made of a low-hardness rubber elastic material or a rubber foamed material is provided on an outer periphery of a conductive metal shaft (core), and an intermediate layer and a surface layer for adjustment of resistance are sequentially laminated as required on the outer periphery thereof. A conductive roll having such a structure has prescribed electric characteristics (resistance value and electrostatic capacity) to transmit a voltage impressed on the core to a photosensitive drum.

More specifically, in order for the charging roll to control charging ability of the photosensitive drum, for the developing roll to control toner charging property and transferability of toner (developing agent) to the photosensitive drum, and for the transfer roll to control transferability of toner to a sheet or to an OHP film, these rolls must have respective prescribed resistance values, and at the same time, it is necessary to achieve a uniform resistance value throughout each roll.

Efforts are made to achieve a uniform target resistance value for these conductive rolls through studies of material properties and structural design. That is, when adding conductive particles (carbon black, in general) which govern the resistance value to layers of the roll, the type, quantity of addition and dispersibility of these particles are controlled so as to achieve a uniform resistance of roll. Use of an ion conductive agent having greater dispersibility than carbon black is being tried. In terms of structural design, efforts are made to achieve a uniform resistance value by using a roll structure comprising a plurality of layers in lamination, and combining resistance values of the individual layers in the lamination in various manners.

The controlled range of the resistance values of conductive rolls varies with the location of the charging roll, the developing roll or the transfer roll, the service conditions and the like. In general, the allowable range for uniformity of resistance value is believed to be such that the difference in the logarithmically converted value between maximum and minimum measured resistance values of the roll, as expressed in the number of digits, should be within 0.3 digits.

The aforementioned conductive rolls such as charging roll, a developing roll or a transfer roll, when used in combination with a photosensitive drum, inevitably come into contact with toner (developing agent). Because, together with coloring particles of carbon black, various additives for controlling charging characteristics, strippability and fixability are added to the interior or exterior of the developing agent, a so-called filming phenomenon tends to be easily caused, in which these interior and exterior additives and a polymer itself of the developing agent are deposited onto the roll surface.

More specifically, applicable interior and exterior additives to the developing agent generally include, in addition to commonly used silica, metal oxides such as aluminum oxide and titanium oxide, metals salts such as calcium sulfate and calcium carbonate, and fatty acid salts such as zinc stearate. Since these substances have a high insulation or a high resistance because of their purpose of use, the roll resistance value increases accordingly as the quantity of deposition onto the roll surface increases. While this increase in resistance value can be compensated through adjustment of the voltage impressed onto the roll, there are blurs in deposition onto the roll surface caused by the filming phenomenon, leading to a non-uniform resistance value for the roll as a whole.

This filming phenomenon is considered to be caused by strippability of the material itself forming the roll surface, forming conditions such as distribution of vulcanizing temperature, or a surface condition of the roll. To eliminate the filming phenomenon, therefore, efforts have conventionally been made to develop a new material and a manufacturing process. Along with the recent achievements of higher speeds and higher image qualities in copying machines and printers, however, the developing agent being used has tended to have a lower melting point and a smaller diameter, and thus the agent is becoming easier to adhere to the roll. As a consequence, deposit blurs tend to become larger, and the resultant image is more susceptible to uneven density.

### SUMMARY OF THE INVENTION

In view of the above-mentioned conventional circumstances, the present invention has an object to provide a conductive roll for an electrophotographic apparatus and a manufacturing method thereof which eliminates deposition blurs caused by the filming phenomenon on the surface of a conductive roll such as a charging roll, a developing roll or a transfer roll, inhibits non-uniform roll resistance values, and gives a satisfactory image free from density blurs.

To achieve the aforementioned object, extensive studies were carried out on adhesion of developing agents and interior and exterior additives to the roll surface. As a result, the following findings were obtained. While it is difficult to completely prevent deposition caused by the filming phenomenon, uniform deposition does not impair uniformity of roll resistance value. A study on the method of promoting uniform deposition on the roll surface on the basis of these findings revealed the effectiveness of a corona treatment of the roll surface.

The present invention therefore provides a conductive roll for an electrophotographic apparatus, having at least an elastic conductive layer provided on an outer periphery of a metal shaft thereof; wherein the roll surface thereof is corona-treated.

The manufacturing method of a conductive roll of the invention comprises the steps of arranging the conductive roll oppositely to, and in parallel with, an electrode for discharging, and corona-treating the surface of the conductive roll by impressing a voltage onto the electrode while rotating the conductive roll.

### BRIEF DESCRIPTION OF THE DRAWINGS

FIG. 1 is a schematic perspective view conceptually illustrating the corona treatment of the conductive roll of the present invention;

FIG. 2 is a schematic perspective view conceptually illustrating a method for measuring the roll resistance value of the conductive roll; and

FIG. 3 is a schematic perspective view conceptually illustrating a method for measuring the resistance value for the entire circumference of a roll so as to evaluate uniformity of resistance value of the conductive roll.

### DESCRIPTION OF THE PREFERRED EMBODIMENTS

The corona treatment used in the present invention is a local discharge phenomenon caused by partial insulation breakage occurring upon emergence of strong unequal electric fields around a conductor, and has conventionally been applied generally for the purpose of improving depositability of a resin material.

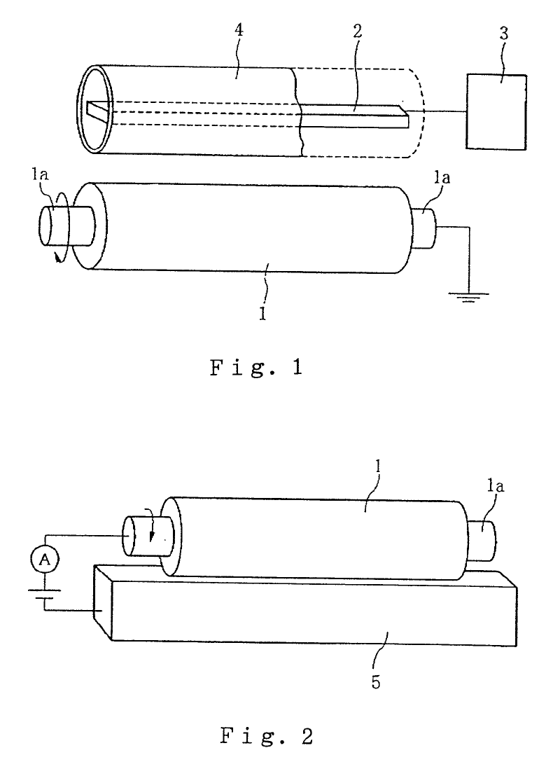

In the method of the invention, more specifically, corona discharge is produced in a conductive roll 1 by arranging a discharging electrode 2 comprising aluminum or the like in parallel with the conductor roll 1 having a grounded shaft 1a (core), for example as shown in FIG. 1, and impressing a prescribed voltage from a power source 3 onto the electrode 2 while rotating the conductor roll 1 at a constant speed. In order to obtain a uniform discharge, an insulator such as a glass tube 4 preferably should be placed between the conductive roll 1 and the electrode 2.

Preferred corona treatment conditions used in the invention include a distance between the conductive roll and the electrode arranged in parallel with each other within a range of from 0.5 to 5.0 mm, a voltage impressed onto the electrode within a range of from 0.1 to 1.0 kW, and a treatment time within a range of from 1 to 600 seconds. With a distance between the conductive roll and the electrode of less than 0.5 mm, a short-circuit leakage may be caused by discharge, and the roll surface may be broken. With a distance of more than 5.0 mm, in contrast, even application of a higher voltage may not cause corona discharge. With a voltage impressed onto the electrode of under 0.1 kW, corona discharge may not occur, and with a voltage of over 1.0 kW, a short-circuit leakage may be caused by discharge, resulting in breakage of the roll surface.

In the invention, although deposition onto the roll surface is caused by filming phenomenon as a result of the corona treatment of the conductive roll surface, the resultant deposition adheres to the surface uniformly. Therefore, while the roll resistance value gradually increases along with the progress of deposition, uniformity of the resistance value throughout a roll is never impaired. Therefore, the conductive roll corona-treated according to the invention, if applied as a charging roll, a developing roll or a transfer roll, can retain stable properties and can give an excellent image which is free from density blurs for a long period of time.

By applying the aforementioned corona treatment, it is possible to achieve a uniform roll resistance value such that the difference (log Rmax/Rmin), as expressed in a number of digits, between the roll maximum resistance value (Rmax) and the minimum resistance value (Rmin) converted logarithmically is within 0.3 digits. It is not as yet clear why the corona treatment gives uniform resistance values for the roll. It is however considered attributable to the fact that roughness of the entire roll surface is on an appropriate level, and at the same time, the quality of the surface as a whole is improved so as to have an appropriate reactivity, thus permitting uniform deposition resulting from the developing agent and the interior and exterior additives onto the roll surface.

With the continued deposition onto the roll surface, the roll resistance continued value gradually increases. By adjusting the voltage impressed onto the roll through the roll core, however, it is possible to control the current value necessary for each roll to a constant value. The corona treatment, being a reforming treatment, does not impair the basic properties of the material composing the roll. Therefore, when dispersing conductive particles such as carbon black particles for controlling electrical characteristics, or setting material properties of the roll such as wear resistance, no restriction is imposed, permitting free design as to the basic configuration of the roll.

Examples of the conductive roll of the invention include a charging roll, a developing roll, and a transfer roll used in an electrophotographic apparatus such as a copying machine or a printer. The structure of the conductive roll is such that at least an elastic conductive layer is provided on an outer periphery of a metal shaft (core). The roll may be one having, for example, a single or multiple rubber layer(s) and/or resin layer(s) on an outer periphery of the elastic conductive layer. These elastic conductive layers may be solid or sponge-like.

There is no particular restriction on the materials of the elastic conductive layer and a single or multiple rubber layer(s) or resin layer(s) provided on the outer periphery thereof. A material capable of being formed into a roll can generally be adopted. More specifically, applicable rubber materials include urethane rubber, nitrile butadiene rubber (NBR), styrene-butadiene rubber (SBR), ethylene-propylene-diene terpolymer (EPDM), chloroprene rubber (CR), silicone rubber, fluororubber, hydrin rubber, isoprene rubber (IR), and butadiene rubber (BR). Applicable resin materials include urethane resin, acrylic resin, nylon resin (polyamide resin), polycarbonate resin, polyvinyl chloride (PVC), polypropylene (PP), and fluororesin. The corona treatment of the invention is particularly effective for silicone rubber, hydrogenated nitrile butadiene rubber (H-NBR) and fluororesin which usually tend to suffer from very non-uniform deposition.

The method of forming the conductive roll will now be briefly described. The method comprises the steps of arranging a metal shaft (core), previously subjected as required to nickel plating on the surface or coated with an adhesive, in a mold divided into an upper portion and a lower portion; filling the cavity between the shaft and the mold with any of the above-mentioned rubber materials or resin materials; and heating and pressurizing the same for a necessary period of time, thereby forming a roll (elastic conductive layer). The rubber materials or the resin materials may be in a molten state, in a solution state dissolved into an organic solvent, or a compound, and may be in any form.

In a typical case, the outer periphery of the roll formed as described above is finished into a necessary cylindrical shape by a technique such as cylindrical polishing or the like. When a layer for resistance adjustment or protection is necessary on the outer periphery of the roll (the elastic conductive layer), a prescribed rubber material or resin material is coated by a dipping process or the like and then heated, thereby forming a single or multiple rubber or resin layer(s). When forming a plurality of layers, it suffices to repeat the aforementioned coating and heating steps a plurality of times.

### EXAMPLES

Conductive roll samples 1 to 4 were manufactured as follows. An electroless Ni plating having a thickness of 4 μm was applied onto the surface of a shaft (core) made of SUM 22 having an outside diameter of 8 mm, and an elastic conductive layer made of NBR having a thickness of 6 mm was formed by mold forming on the outer periphery of the shaft. The resultant structure was cylindrically polished into roll sample 1. In place of the elastic conductive layer comprising NBR of the above-mentioned roll sample 1, an elastic conductive layer made of SBR having a thickness of 6 mm was formed by mold forming into a roll; a surface layer made of nylon resin having a thickness of 10 μm was coated thereon; and the same was cylindrically polished into roll sample 2.

Roll sample 3 was prepared in the same manner as in roll sample 2, except that the elastic conductive layer comprised of silicone rubber having a thickness of 6 mm, with a plurality of surface layers comprising an intermediate layer made of H-NBR having a thickness of 10 μm and an outermost layer made of fluororubber having a thickness of 10 μm. Roll sample 4 was prepared in the same manner as in roll sample 2, except that roll sample 4 had a surface layer comprising an inner layer made of nylon resin having a thickness of 10 μm, an intermediate layer made of NBR having a thickness of 100 μm, and an outermost layer made of nylon resin having a thickness of 10 μm.

For the aforementioned conductive rolls of samples 1 to 4, the configurations are shown in the following table 1 in the order from the shaft at the center toward outside. All the rolls of samples 1 to 4 have an outside diameter of about 20 mm and a length of the rubber portion of about 300 mm. Table 1

Roll of sample 1

Shaft: SUM 22 (outside diameter: 8 mm, electroless Ni plating: 4 μm)

Elastic layer: NBR (thickness: 6 mm)

Roll of sample 2

Shaft: SUM 22 (outside diameter: 8 mm, electroless Ni plating: 4 μm)

Elastic layer: SBR (thickness: 6 mm)

Surface layer: Nylon resin (thickness: 10 μm)

Roll of sample 3

Shaft: SUM 22 (outside diameter: 8 mm, electroless Ni plating: 4 μm)

Elastic layer: Silicone rubber (thickness: 6 mm)

Intermediate layer: H-NBR (thickness: 10 μm)

Outermost layer: Fluororubber (thickness: 10 μm)

Roll of sample 4

Shaft: SUM 22 (outside diameter: 8 mm, electroless Ni

plating: 4 μm)

Elastic layer: SBR (thickness: 6 mm)

Inner layer: Nylon resin (thickness: 10 μm)

Intermediate layer: NBR (thickness: 100 μm)

Outermost layer: Nylon resin (thickness: 10 μm)

The conductive rolls of samples 1 to 4 were corona-treated by using a conventional corona discharge unit. More specifically, as shown in FIG. 1, a conductive roll 1 is arranged below an aluminum electrode 2 covered with a glass tube 4 on the exterior, with the roll surface in parallel with the electrode 2 and with a gap of 2 mm in between. A voltage of an output of 0.2 kW was impressed onto the electrode 2 while rotating the conductive roll 1 at 20 rpm and earthing the shaft 1a of the conductive roll 1. Corona discharge was conducted for a period of 60 seconds.

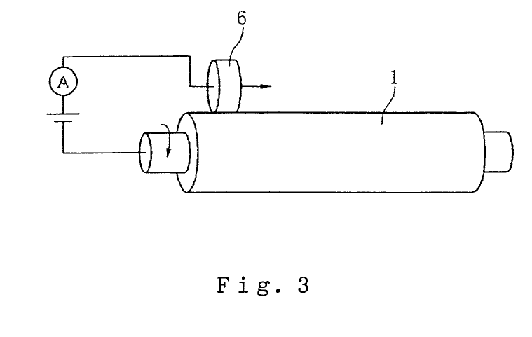

For each of the resultant rolls of the samples 1 to 4 of the present invention, the roll resistance value was measured, and uniformity of resistance values in the rolls was evaluated. The results are shown in the following Table 2. More specifically, the roll resistance value was determined by placing the conductive roll 1 on a metal flat plate 5, as shown in FIG. 2, impressing a voltage of DC 100 V between the shaft 1a and the metal plate 5 while the conductive roll 1 is pressed against the metal plate 5 by applying a load of 500 gf at both ends of the shaft 1a, and measuring the quantity of current flowing between the shaft 1a and the metal plate 5.

As to uniformity of resistance values within a roll, a resistance value throughout the entire surface of each roll was determined by pressing a metal roller 6 (bearing) having a width of 12 mm against the outer periphery of the conductive roll 1 with a load of 100 gf, impressing a voltage of DC 100 V between the metal roller 6 and the shaft 1a of the conductive roll 1 while moving the metal roller 6 in the axial direction as the conductive roll 1 is rotated, and measuring the quantity of current flowing between the shaft 1a and the metal roller 6. The resistance values were thus measured for the entire surface of the conductive roll. The thus determined maximum resistance value Rmax and minimum resistance value Rmin were logarithmically converted, and the determined difference between them (log Rmax/Rmin) was expressed in the forms of number of digits.

A durability test was carried out by assembling each of the conductive rolls of samples 1-4 of the invention as a transfer roll of a laser beam printer, continuously driving the same under conditions including a temperature of 30° C. and a humidity of 85%, and actually printing an image on 10,000 sheets. For each sample transfer roll after the completion of this durability test, measurement of the roll resistance value and evaluation of uniformity of resistance value within a roll were conducted in the same manner as described above, and deposition onto the roll surface was observed. The results are shown in the following Table 2. Criteria for the evaluation of deposition included “no deposition” for a state free from deposition or the slightest deposition, “uneven deposition” showing presence of deposition but differences in the quantity of deposition between difference portions, and “uniform deposition” expressing a state in which uniform deposition over the entire surface.

As comparative examples, rolls having the same structures as the samples 1 to 4 shown in Table 1, but not subjected to a corona treatment, were prepared and used as comparative samples 1 to 4. Measurement of roll resistance value, evaluation of uniformity of resistance value within a roll, resistance value and uniformity of resistance value after a durability test, and evaluation of deposition were carried out on these comparative samples. The results are shown also in Table 2.

TABLE 2

| | Roll Resistance Value | | Uniformity of Resist- | | |
|---|---|---|---|---|---|
| | (Ω) | | ance Value | | |
| | Initial | After | Initial | After | |
| Roll Sample | Value | Endurance | Value | Endurance | Deposition |
| Sample 1 of Invention | 3.00 × 10⁴ | 7.00 × 10⁵ | 0.2 Digits | 0.3 Digits | Uniform Deposition |
| Sample 2 of Invention | 4.70 × 10⁸ | 5.90 × 10⁸ | 0.2 Digits | 0.2 Digits | Uniform Deposition |
| Sample 3 of Invention | 6.50 × 10⁷ | 3.30 × 10⁸ | 0.2 Digits | 0.3 Digits | Uniform Deposition |
| Sample 4 of Invention | 1.20 × 10⁶ | 7.20 × 10⁷ | 0.2 Digits | 0.2 Digits | Uniform Deposition |
| Comparative Sample 1 | 3.10 × 10⁴ | 8.90 × 10⁴ | 0.2 Digits | 0.8 Digits | Uneven Deposition |
| Comparative Sample 2 | 5.80 × 10⁸ | 1.20 × 10⁹ | 0.2 Digits | 1.3 Digits | Uneven Deposition |
| Comparative Sample 3 | 2.70 × 10⁷ | 7.30 × 10³ | 0.2 Digits | 0.9 Digits | Uneven Deposition |
| Comparative Sample 4 | 1.10 × 10⁶ | 4.40 × 10⁶ | 0.2 Digits | 1.5 Digits | Uneven Deposition |

As is evident from the results shown above, deposition onto the roll surface was caused by filming phenomenon by printing an image on the rolls in all cases, and the roll resistance value increased. In the samples of the invention subjected to a corona treatment of the surface, uniformity of roll resistance value was not impaired, and the difference in logarithmically converted value (log Rmax/Rmin) between the maximum resistance value (Rmax) and the minimum resistance value (Rmin) was maintained within the preferable 0.3 digits.

In the rolls of the comparative samples, in contrast, deposition non-uniformly adhered to the roll surface, resulting in a very large logarithmically converted difference (log Rmax/Rmin) between the maximum resistance value (Rmax) and the minimum resistance value (Rmin) of over 0.8 digits, and uniformity of resistance values could not be maintained.

In the above-mentioned durability test, the image obtained on the sheet upon completion of actual printing of the image on 10,000 sheets was observed and evaluated. When using the rolls of the samples of the invention, excellent images free from density unevenness were obtained. However, density unevenness was observed in all the rolls of the comparative samples. This suggests that, by using a conductive roll of the present invention, it is possible to stably obtain a satisfactory image free from density unevenness for a long period of time.

According to the present invention, depositions uniformly adhere to the roll surface as a result of filming phenomenon by applying a simple method known as corona treatment, thus resulting in uniform deposition free from unevenness. It is thus possible to eliminate unevenness of resistance value within a conductive roll. Therefore, by using the conductive roll of the present invention as a charging roll, a developing roll or a transfer roll in an electrophotographic apparatus, an image free from density unevenness can be stably obtained for a long period of time.

The corona treatment used in the present invention is a reforming treatment of a roll surface, and does not impair the basic properties of the material composing the conductive roll. When selecting dispersing charging particles such as carbon black particles or properties of a roll material, therefore, freedom in design is permitted regarding the basic roll configuration, such is not subjected to any restriction.

What is claimed is:

1. A conductive roll for an electrophotographic apparatus, the roll comprising at least an elastic conductive layer provided on an outer periphery of a metal shaft; wherein the roll surface thereof is corona-treated.

2. A conductive roll according to claim 1, wherein at least one second layer is provided on the outer periphery of said elastic conductive layer, and the surface of the second layer made of a polyamide resin.

3. A manufacturing method of a conductive roll for an electrophotographic apparatus, having at least an elastic conductive layer provided on an outer periphery of a metal shaft, comprising the steps of arranging the conductive roll oppositely to, and in parallel with, an electrode for discharging, and corona-treating the surface of said conductive roll by impressing a voltage onto said electrode while rotating said conductive roll.

4. A manufacturing method of a conductive roll according to claim 3, wherein the distance between said conductive roll and the electrode is within a range of from 0.5 to 5.0 mm, and the voltage impressed onto said electrode is within a range of from 0.1 to 1.0 kW.

5. A manufacturing method of a conductive roll according to claim 3, wherein at least one second layer is provided on the outer periphery of said elastic conductive layer, and the surface layer of the second layer made of a polyamide resin.

6. A manufacturing method of a conductive roll according to claim 4, wherein at least one second layer is provided on the outer periphery of said elastic conductive layer, and the surface layer of the second layer made of a polyamide resin.
